(19) United States
(12) Patent Application Publication
(10) Pub. No.: US 2008/0167021 A1
(43) Pub. Date: Jul. 10, 2008

(54) Mobile terminal

(75) Inventors: Kenichi Koga, Ome-shi (JP); Tomohiro Yoshida, Ome-shi (JP); Akira Takamune, Tachikawa-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/903,167

(22) Filed: Sep. 20, 2007

(30) Foreign Application Priority Data
Jan. 9, 2007 (JP) 2007-001591

(51) Int. Cl. H04M 3/42

(52) U.S. Cl. 455/415

(57) ABSTRACT

When a remote device returns an address in response to a search signal, a control unit searches a phone book memory based on this address, reads the user name of the corresponding remote device, and displays it on a display unit. On the other hand, when the phone book memory does not store the user name of the corresponding remote device, the control unit receives the device name from the remote device, and displays it on the display unit. When the control unit cannot receive this device name, the control unit displays the address on the display unit.

### CROSS-REFERENCE TO RELATED APPLICATIONS

This application is based upon and claims the benefit of priority from prior Japanese Patent Application No. 2007-001591, filed Jan. 9, 2007, the entire contents of which are incorporated herein by reference.

### BACKGROUND OF THE INVENTION

1. Field of the Invention

The present invention relates to a mobile terminal such as a cellular phone or personal digital assistant (PDA) and, more particularly, to a mobile terminal including a local radio communication interface.

2. Description of the Related Art

Recently, a mobile terminal represented by a cellular phone increasingly includes a local radio communication interface such as Bluetooth® in addition to an original mobile radio communication interface. When, for example, a plurality of neighboring mobile terminals each have such local radio communication interface, they can be connected and communicate with each other via a local radio communication network.

Note that the mobile terminal which includes the Bluetooth® interface generally has a Bluetooth® table. The Bluetooth® table includes areas for respectively storing a device name, Bluetooth® address, device type, and support service type. In the areas for storing the Bluetooth® address, device type, and support service type, pieces of information set by a manufacturer before shipping are generally written. On the other hand, no information is stored in the device name storage area, and a user can arbitrarily write a user name or the like by a key input operation in many cases.

In order to perform chat communication with a remote mobile terminal via Bluetooth®, the mobile terminal as a request source first performs a search operation. The communicable remote mobile terminals (to be referred to as remote devices hereinafter) which have responded to this search operation return the pieces of their own Bluetooth® table information. If the returned Bluetooth® table information contains the device names, the mobile terminal as the request source displays a list of device names on a display device. If the returned Bluetooth® table information does not contain any device name, the mobile terminal displays a list of Bluetooth® addresses on the display device. When the user selects a chat partner based on the remote device information listed and displayed on the display device, a Bluetooth® connection sequence is implemented with the selected partner terminal, and communication can be performed (e.g., see Jpn. Pat. Appln. KOKAI Publication No. 2004-343219).

However, if the Bluetooth® table information transmitted from the remote device does not contain any device name, the conventional mobile terminal unconditionally displays the Bluetooth® address. Hence, when the Bluetooth® address is displayed, the user of the mobile terminal as the request source can neither recognize a partner user, nor smoothly select a communication partner terminal.

### BRIEF SUMMARY OF THE INVENTION

It is an object of the present invention to provide a mobile terminal which allows a user to smoothly recognize a communication partner in local radio communication.

In order to achieve the above object, according to an aspect of the present invention, a mobile terminal includes a cellular radio communication unit configured to perform cellular radio communication with a base station, a local radio communication unit configured to perform local radio communication with a remote terminal, a storage unit configured to store information, a display unit configured to display information, and a control unit. The storage unit further includes a phone book memory configured to store phone book data containing at least a user name of the remote terminal, which represents the remote terminal estimated as a communication destination in the cellular radio communication or the local radio communication. On the other hand, the control unit includes a first control module configured to receive, via the local radio communication unit, local radio communication terminal identification information which is transmitted from the remote terminal and contains at least an address of the remote terminal, a second control module configured to determine whether the phone book memory stores the address contained in the received terminal identification information, and a third control module configured to read the user name of the remote terminal corresponding to the address from the phone book memory and display the read user name on the display unit, when it is determined that the phone book memory stores the address contained in the received terminal identification information.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the arrangement of a cellular phone as an embodiment of a mobile terminal according to the present invention;

FIG. 2 is a block diagram showing the arrangement of a control unit of the cellular phone shown in FIG. 1;

FIG. 3 is a view showing an example of a Bluetooth® table in a storage unit of the cellular phone shown in FIG. 1;

FIG. 4 is a view showing an example of a phone book database in the storage unit of the cellular phone shown in FIG. 1;

FIG. 5 is a flowchart showing the start portion of a chat request control sequence and its form performed by the control unit shown in FIG. 2;

FIG. 6 is a flowchart continued from FIG. 5 and showing the mid portion along the chat request control sequence and its form performed by the control unit shown in FIG. 2;

FIG. 7 is a flowchart continued from FIG. 6 and showing the mid portion along the chat request control sequence and its form performed by the control unit shown in FIG. 2;

FIG. 8 is a flowchart continued from FIG. 7 and showing the end portion of the chat request control sequence and its form performed by the control unit shown in FIG. 2;

FIG. 9 is a flowchart showing the first half of a chat request response control sequence and its form performed by the control unit shown in FIG. 2;

FIG. 10 is a flowchart showing the second half of the chat request response control sequence and its form performed by the control unit shown in FIG. 2;

FIG. 11 is a view showing a transition example of display data obtained by control processing shown in FIGS. 5 to 8; and

FIG. 12 is a view showing a transition example of display data obtained by control processing shown in FIG. 9.

### DETAILED DESCRIPTION OF THE INVENTION

An embodiment of the present invention will be described below with reference to the accompanying drawing.

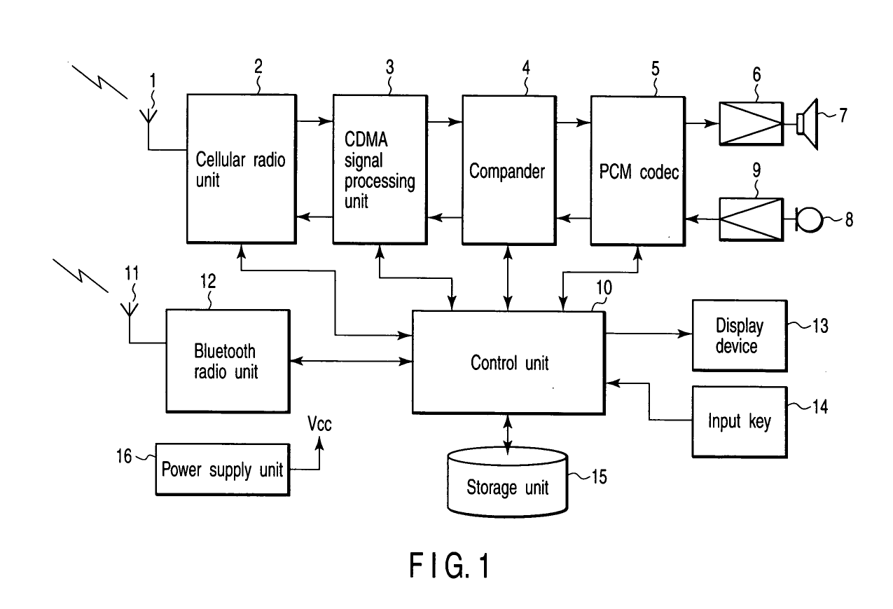

FIG. 1 is a block diagram showing the arrangement of a cellular phone as an embodiment of a mobile terminal according to the present invention.

A radio signal transmitted from a base station (not shown) in a cellular system is received by a cellular communication antenna 1, and input to a cellular radio unit 2. The cellular radio unit 2 includes a receiving circuit and a transmitting circuit. The receiving circuit mixes the input radio signal with a reception local oscillation signal, thereby down-converting the signal into an intermediate-frequency or a baseband-frequency reception signal. The receiving circuit processes this down-converted reception signal by quadrature demodulation, and outputs a reception baseband signal.

The reception baseband signal is input to a code division multiple access (CDMA) signal processing unit 3. The CDMA signal processing unit 3 includes a RAKE receiver. The RAKE receiver despreads a plurality of passes included in the reception baseband signal by using spreading codes. The signals of these despread passes are synthesized after their phases are arbitrated. In this manner, reception packet data having a predetermined transmission format is obtained. This reception packet data is input to a compressing/expanding unit (to be referred to as a compander hereinafter) 4.

In a speech mode, the compander 4 decodes, by a speech codec, audio data in the reception packet data output from the CDMA signal processing unit 3. A digital audio signal obtained by the decoding process is output to a pulse code modulation (PCM) coder/decoder (to be referred to as a PCM codec hereinafter) 5. The PCM codec 5 decodes the digital audio signal by PCM, and outputs an analog speech signal. This analog speech signal is amplified by a reception amplifier 6, and output from a loudspeaker 7 as sound.

When an e-mail message is received or content is downloaded, the compander 4 outputs the e-mail data or content data in the reception packet data to a control unit 10. The control unit 10 stores the e-mail data or content data in a reception data memory included in a storage unit 15, and reads the stored data from the storage unit 15, and displays it on a display device 13.

A speech signal of a speaker input to a microphone 8 in the speech mode is amplified to an appropriate level by a transmission amplifier 9, coded into a digital audio signal by PCM by the PCM codec 5, and input to the compander 4. Also, an output video signal from the camera (not shown) is converted into a digital signal by the control unit 10, and input to the compander 4. Note that text data such as e-mail formed by the control unit 10 is also input from the control unit 10 to the compander 4.

The compander 4 detects the energy amount of the input speech from the digital audio signal output from the PCM codec 5, and determines a transmission data rate on the basis of the detection result. Then, the compander 4 codes the digital audio signal into a signal having a format corresponding to the transmission data rate, thereby generating audio data. Also, the compander 4 codes the digital video signal output from the control unit 10, and generates video data. The multiplexer/demultiplexer multiplexes these audio data and video data in accordance with a predetermined transmission format to generate transmission packet data, and outputs this transmission packet data to the CDMA signal processing unit 3. Note that when the text data such as e-mail is output from the control unit 10, this text data is also multiplexed into packet data.

The CDMA signal processing unit 3 spreads the spectrum of the output transmission packet data from the compander 5 by using a spreading code allocated to a transmission channel, and outputs the signal to the transmitting circuit of the cellular radio unit 2. The transmitting circuit modulates the signal having the spread spectrum by using a digital modulation method such as quadrature phase shift keying (QPSK) or quadrature amplitude modulation (QAM). The transmitting circuit synthesizes the modulated transmission signal with the transmission local oscillation signal, thereby up-converting the signal into a radio signal. Then, the transmitting circuit amplifies the radio signal to a high frequency so that the transmission power level designated by the control unit 10 is obtained. The amplified radio signal is supplied to the cellular communication antenna 1, and transmitted from the antenna 1 to the base station.

The cellular phone according to this embodiment includes a Bluetooth® radio unit 12. The Bluetooth® radio unit 12 executes Bluetooth® radio communication with a remote terminal via a Bluetooth® communication antenna 11 under control of the control unit 10. Note that Bluetooth® radio communication uses a frequency hopping spread-spectrum scheme as a modulation scheme.

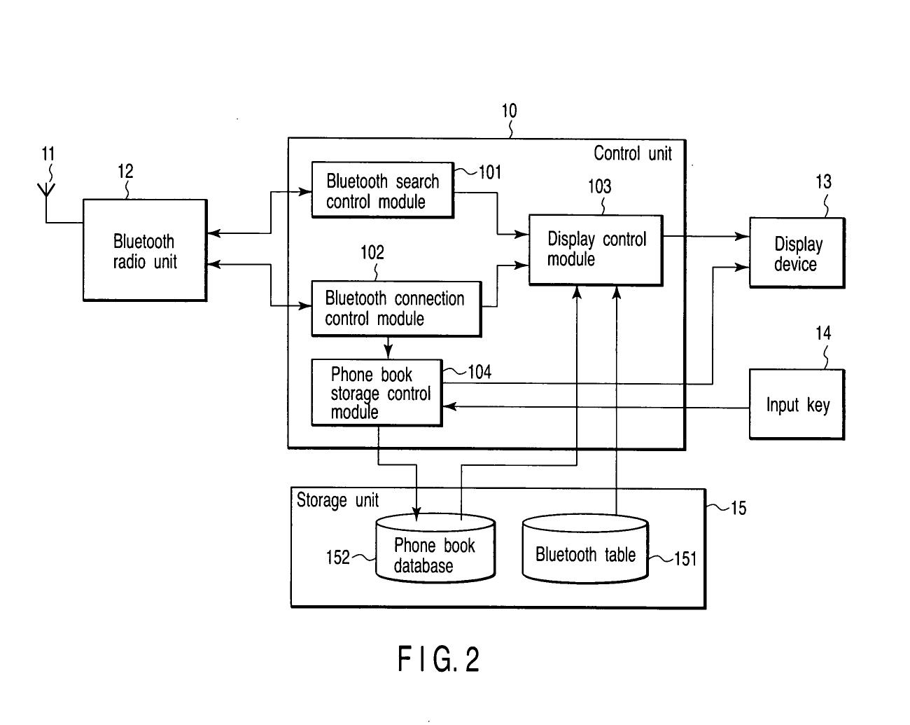

The arrangement of the control unit 10 and the storage unit 15 will be described as follows. FIG. 2 is a block diagram showing the arrangement of these units.

The storage unit 15 includes a Bluetooth® table 151 and a phone book database 152 in addition to the above-described reception data memory.

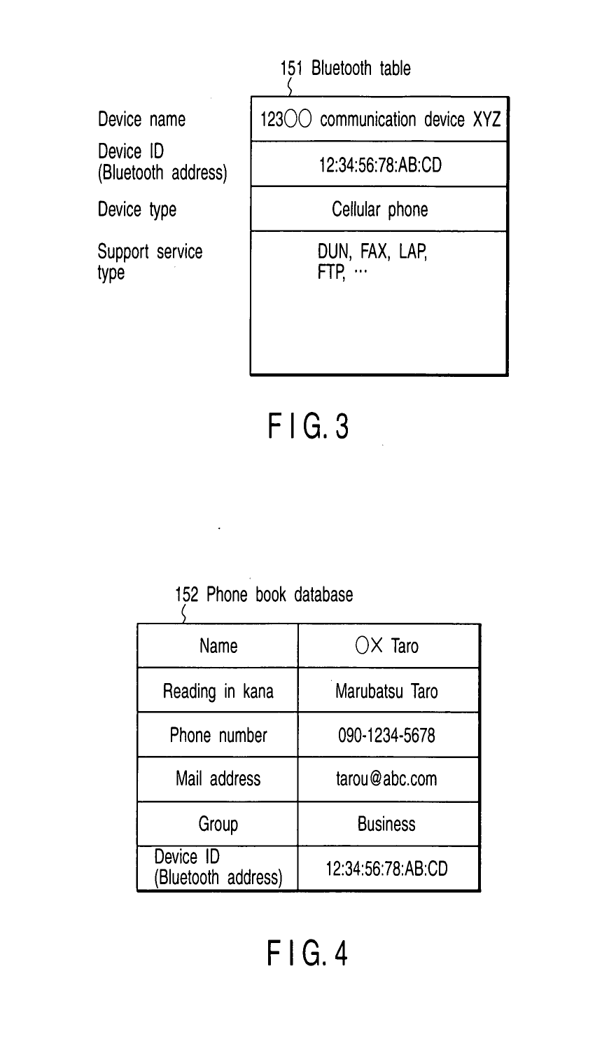

As shown in FIG. 3, the Bluetooth® table 151 includes areas for respectively storing a device name, device ID, device type, and support service type.

When shipping from a manufacturer, no information is written in the device name storage area. After the start of use, the control unit 10 writes a device type such as “12300 communication device xyz” shown in FIG. 3, which is stored in advance by the manufacturer of the cellular phone. The user can also write the user name by operating an input key 14.

A Bluetooth® address is written in the device ID storage area. The Bluetooth® address is represented by a 12-digit number expressed by a hexadecimal value (four bit), e.g., “12:34:56:78:AB:CD”. The manufacturer uniquely assigns the address numbers to the cellular phones to prevent the address numbers from being duplicated, and manages them. When manufacturing or shipping the cellular phone, the address number is written in each device ID storage area. Once the address is written, it cannot be rewritten.

In the device type storage area, information representing the device type of a radio communication terminal device. For example, as shown in FIG. 3, “Cellular phone” is written. Once the device type information is written, it cannot be rewritten, similar to the above-described address.

In the support service type storage area, a list of profiles representing the types of Bluetooth® services supported by the cellular phone is written. As the support service types, “Dial-Up Network profile (DUN)”, “FAX profile (FAX)”, “LAN Access Profile (LAP)”, “File Transfer Protocol profile (FTP)”, and the like are written. Once the list of profiles representing the support service types is written, it cannot be rewritten.

The phone book database 152 stores phone book data containing the identification information and attribute information of each user as a transmission destination or transmission source. As shown in FIG. 4, the phone book data of one user contains, e.g., the name, reading in kana, telephone number, mail address, group, and Bluetooth® address of the user.

The control unit 10 has a central processing unit (CPU) comprising a microprocessor. The control unit 10 also includes a Bluetooth® search control module 101, Bluetooth® connection control module 102, display control module 103, and phone book registration control module 104 as control functions of the present invention. The functions of the control modules 101 to 104 can be implemented by causing the CPU to execute application programs.

When the user inputs a chat start request by using the input key 14, the Bluetooth® search control module 101 controls to operate in synchronism with a chat application program and transmit a search signal to the remote terminals. The Bluetooth® search control module 101 receives response signals returned from the remote terminals in response to the search signal, and determines the presence/absence of a communicable remote device based on the reception result of the response signal. Upon reception of a search signal transmitted from another terminal in a standby state, the Bluetooth® search control module 101 controls to return a response signal containing the Bluetooth® address of the mobile terminal.

When a remote device is found based on the Bluetooth® search result and the user selects the remote device as a chat partner by operating the input key 14, the Bluetooth® connection control module 102 controls to execute the Bluetooth® connection sequence defined in advance based on a standard with the remote device, and establish a radio link. This connection sequence includes an authentication sequence using a personal identification number (PIN).

Upon finding the remote device based on the Bluetooth® search result, the display control module 103 controls to search the phone book database 152 based on the Bluetooth® address in the response signal transmitted from the remote device, read the corresponding user name, and display it on the display device 13. When the phone book database 152 does not store the corresponding user name, the display control module 103 controls to acquire the device name of the remote device and display it on the display device 13. When the device name cannot be acquired, the display control module 103 controls to display the Bluetooth® address on the display device 13.

The phone book registration control module 104 determines whether the phone book database 152 store the terminal information of the remote device which establishes the radio link by using the Bluetooth® connection control module 102. If the phone book database 152 does not store the terminal information based on the determination result, the phone book registration control module 104 displays, on the display device 13, a message for inquiring of the user whether to store the terminal information. In accordance with the user's instruction operation in response to this inquiry, the phone book registration control module 104 controls to additionally store, in the phone book database 152, the device name or Bluetooth® address transmitted from the remote device in search control processing.

Note that a power supply unit 16 generates a predetermined operation power supply voltage Vcc based on the output of the battery, and applies the voltage to each circuit unit. The battery is charged by a charging circuit.

The operation of the cellular phone having the above-described arrangement will be described next by exemplifying the operation of a chat between the cellular phones.

(1) Chat Request Operation of Cellular Phone

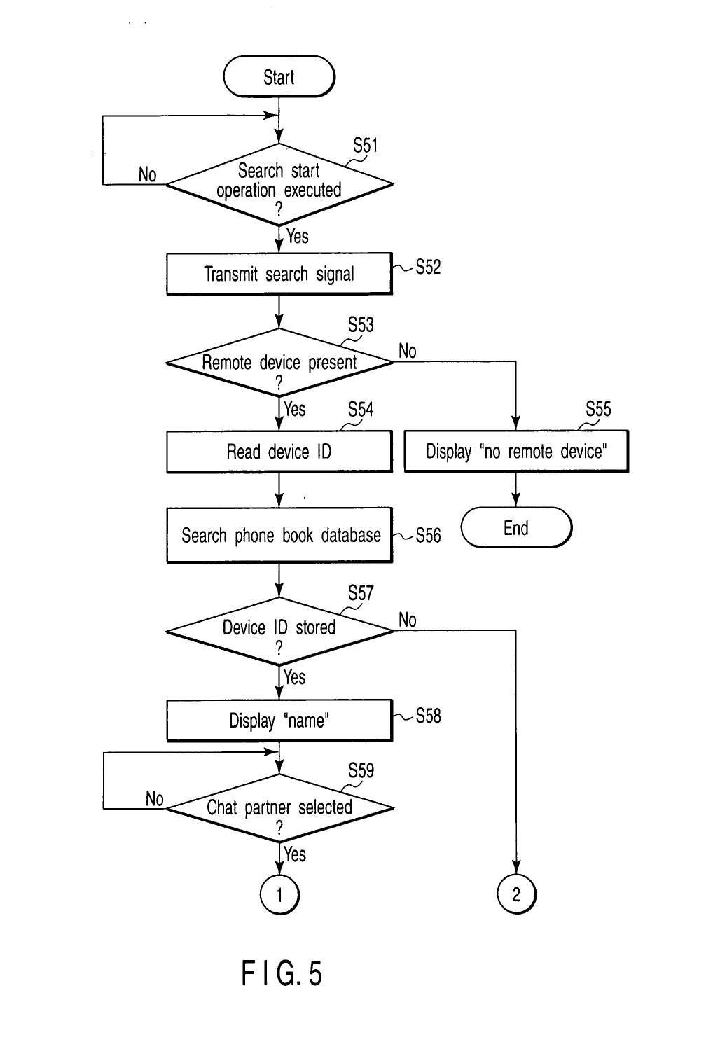

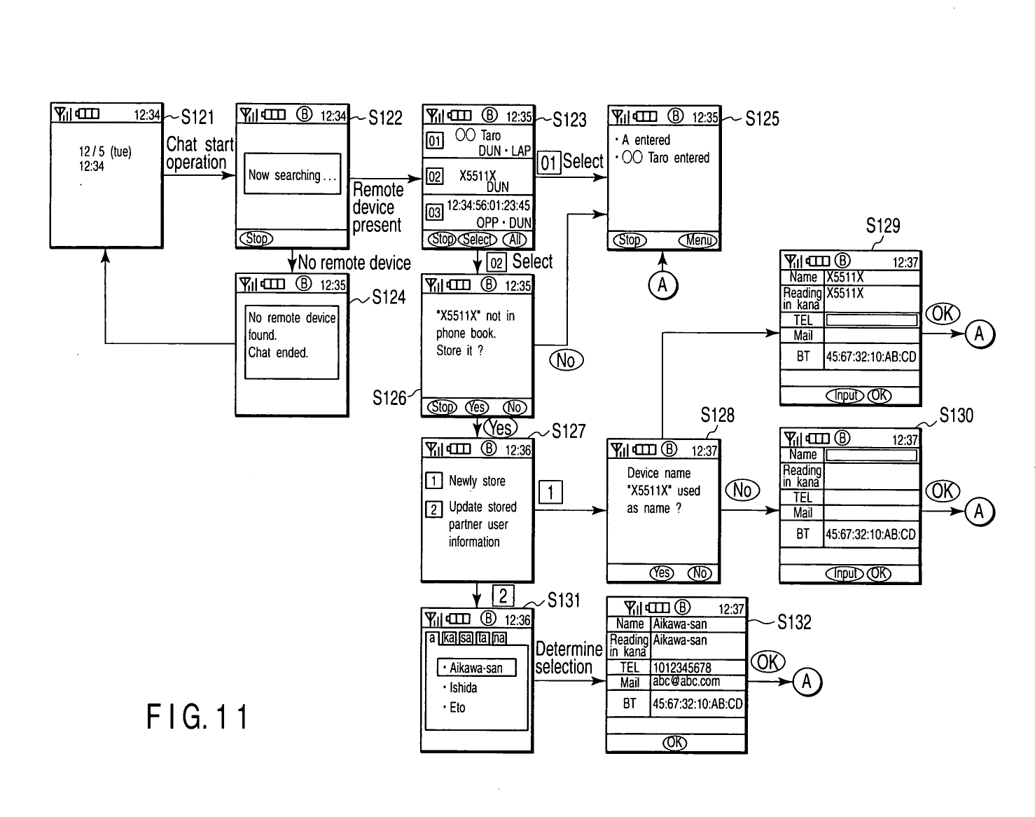

When the user operates the input key 14 in the standby state to input a chat start request, the control unit 10 controls to start a chat by using a Bluetooth® radio communication function, as follows. FIGS. 5 to 8 are flowcharts showing the control sequence and control form, and FIG. 11 is a view showing an example of information displayed on the display device 13 in this control processing.

That is, the control unit 10 monitors a search start request operation in step S51 in the standby state (S121 in FIG. 11). Upon performing the chat start request operation in this state, the control unit 10 transmits a search signal from the Bluetooth® radio unit 12 to the remote terminals in step S52. At this time, the display device 13 displays a message “Now searching . . .” as shown in S122 in FIG. 11. If there is a remote device which can receive the search signal and if the Bluetooth® radio unit 12 receives a response signal returned from the remote device, the control unit 10 stores this response signal in an internal memory, and determines, in step S53, the presence/absence of a remote device based on the reception result.

Assume that no remote device is found based on this determination result. In step S55, the control unit 10 displays, on the display device 13, a message representing that no remote device is found. After that, the control unit 10 returns to the standby state. For example, as shown in S124 in FIG. 11, a message “No remote device found. Chat ended.” is used.

Assume that a remote device is found in search control processing. In this case, in step S54, the control unit 10 reads the device ID (Bluetooth® address) in the stored response signal from the internal memory. Based on the read device ID, the control unit 10 searches the phone book database 152 in step S56, and determines in step S57 whether the phone book database 152 stores the device ID. If the phone book database 152 stores the device ID based on the determination result, the control unit 10 reads the corresponding user name from the phone book database 152 in step S58, and displays it on the display device 13. In “01” of S123 in FIG. 11, such user name is displayed as an example, and the support service type is displayed together.

Accordingly, even when the response signal returned from a remote device in the search processing contains only the device ID, the user can recognize the user name of the remote device which has responded to the inquiry. When the user operates the input key 14 to select the chat partner in this state, the control unit 10 finds the selection operation in step S59, and shifts to the Bluetooth® connection control operation (to be described later).

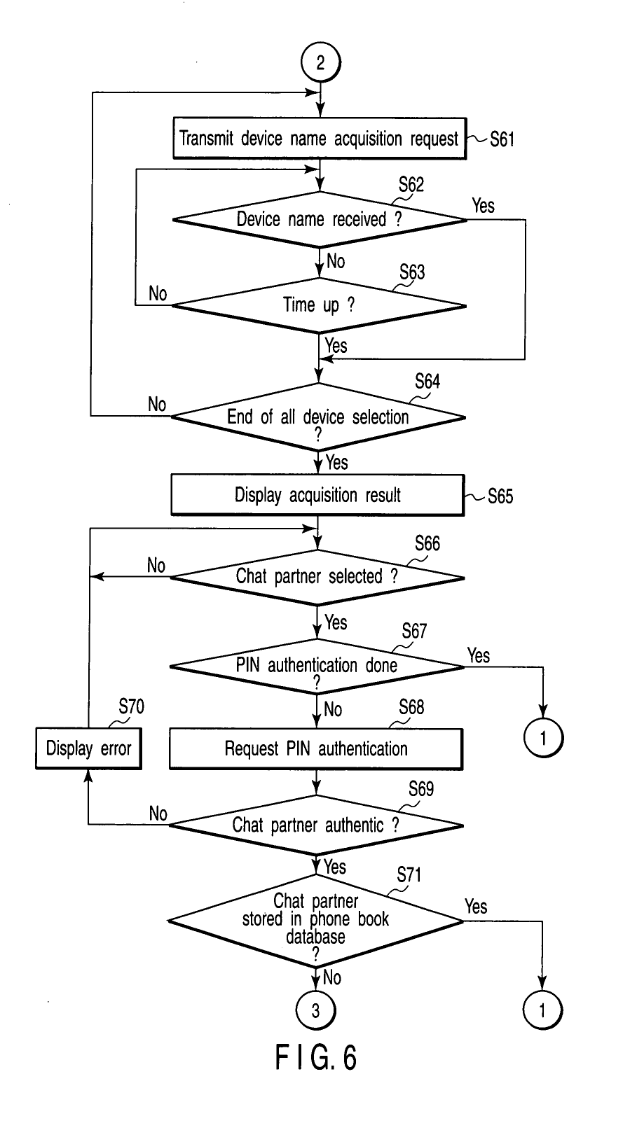

On the other hand, assume that the phone book database 152 does not store any device ID based on the determination result in step S57. In this case, in step S61 shown in FIG. 6, the control unit 10 first transmits a device name acquisition request to the remote device which has responded to the inquiry. After that, the control unit 10 monitors in step S62 whether the device name is returned, while monitoring a time up in step S63. In this state, when the remote device returns information representing the device name within a predetermined period of time after transmission of the acquisition request, the control unit 10 receives and stores the device name information in step S62. When there are plurality of remote devices, the control unit 10 repeatedly performs the device name acquisition process for all the remote devices.

Upon completion of the device name acquisition processes for all the remote devices, the process shifts from step S64 to step S65, and the control unit 10 displays a list of acquired device names and corresponding service types on the display device 13. In “02” of S123 in FIG. 11, one of such device names is displayed as an example. In this manner, the user can estimate the partner user based on the device name transmitted from the remote device, even when the phone book database 152 does not store any corresponding user name.

Note that when the device name of a remote device cannot be acquired based on the device name acquisition process, the Bluetooth® address of the remote address stored in the internal memory is displayed on the display device 13 together with the support service type. In “03” of S123 in FIG. 11, such Bluetooth® address is displayed as an example.

Assume that the user operates the input key 14 to select a chat partner in a state wherein a list of remote devices is displayed. In this case, the control unit 10 executes connection control with a remote device as follows.

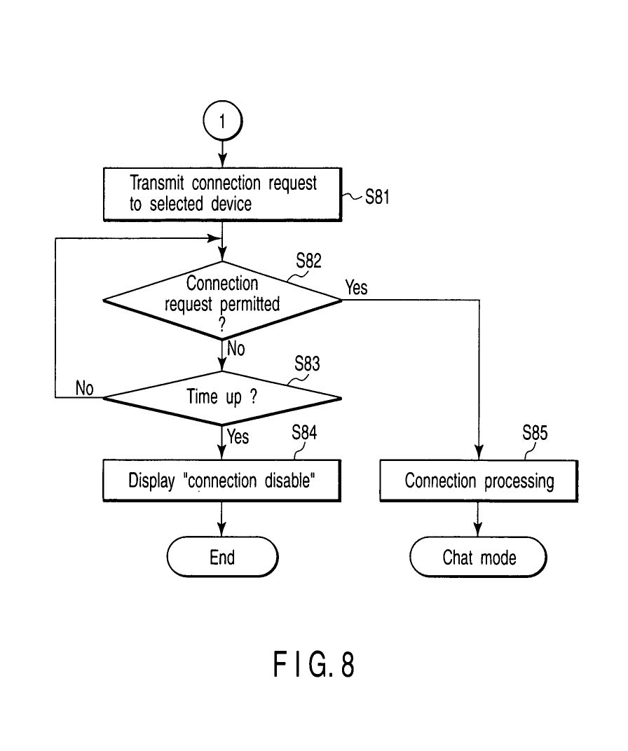

That is, assume that the user selects “01” in which the partner user name is displayed, from the list of remote devices shown in S123 in FIG. 11. In this case, the process shifts from step S59 to step S81 shown in FIG. 8, and the control unit 10 transmits a connection request to the selected remote device. The control unit 10 monitors in step S82 whether the remote device returns the response signal while monitoring the elapsed time in step S83. In this state, assume that the remote device returns the response signal for permitting connection within a predetermined period of time from when the connection request is transmitted. In this case, the process shifts to step S85, and the control unit 10 executes the connection process. After the radio link is established, the control unit 10 displays, on the display device 13, the message representing the state of the user of the remote device as shown in S125 in FIG. 11. After that, the control unit 10 shifts to a chat mode.

Assume that the user selects “02” in which a partner device name is displayed, in a state wherein a list of remote devices is displayed. In this case, the process shifts from step S66 to step S67, and the control unit 10 determines whether PIN authentication has been done with the partner remote device. If PIN authentication has been done, the process shifts to step S81 as described above, and the control unit 10 executes a series of connection processes from transmission of the connection request.

On the other hand, if PIN authentication has not been done, the control unit 10 executes a process for PIN authentication with the partner remote device in step S68. If the authenticity of the partner remote device is confirmed based on this authentication result, the process shifts from step S59 to step S71, and the control unit 10 determines whether the phone book database 152 of the mobile terminal stores the partner remote device. If the phone book database 152 stores the partner remote device, the process shifts to step S81, and the control unit 10 executes the series of connection processes from transmission of the connection request. If the authenticity of the partner remote device cannot be confirmed based on the PIN authentication result, the control unit 10 displays an error message on the display device 13 in step S70, and returns to the standby state for the selection operation of a chat partner in step S66.

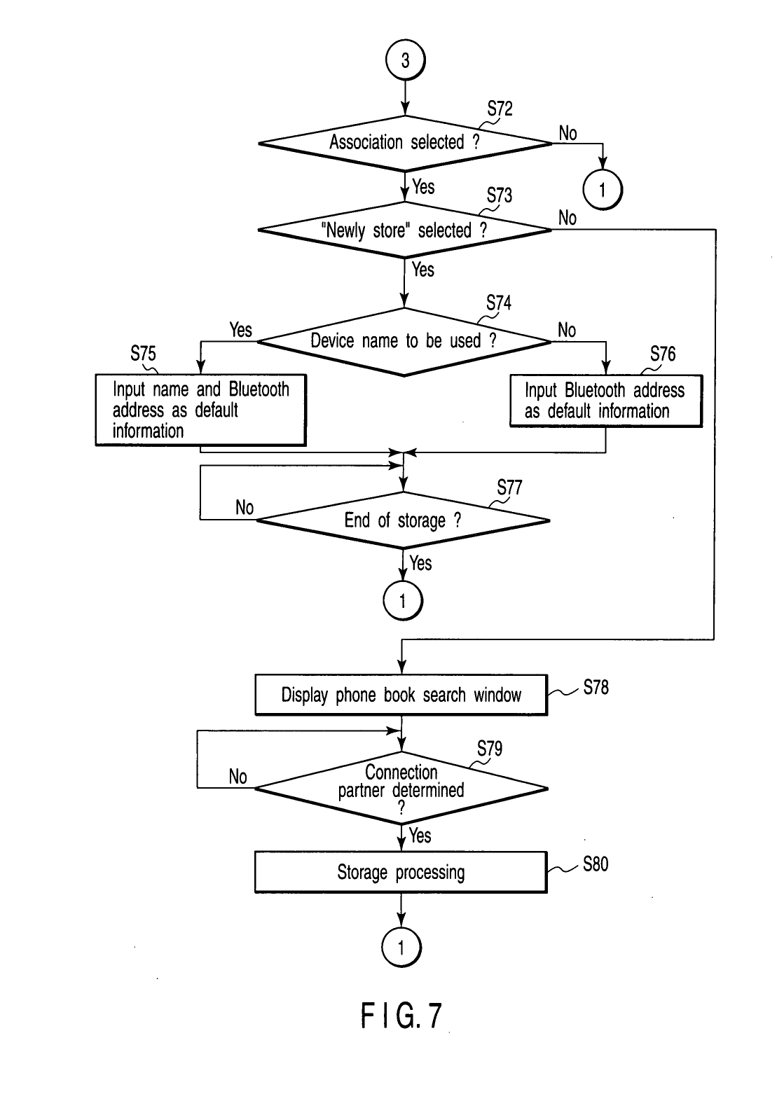

On the other hand, assume that the phone book database 152 does not store any Bluetooth® address of the remote device selected as the chat partner, based on the determination result in step S71. In this case, the control unit 10 controls to additionally store the remote device information in the phone book database 152, as follows. FIG. 7 is a flowchart showing the control sequence and control form.

That is, as shown in S126 in FIG. 11, the control unit 10 first displays, on the display device 13, a message for inquiring of the user whether to store the remote device information in the phone book database 152. If the user selects “Not store” in this state, the process shifts from step S72 to step S81 as described above, and the control unit 10 executes the series of connection processes from transmission of the connection request.

On the other hand, assume that the user selects “store”. In this case, in step S73, the control unit 10 displays, on the display device 13, a message for inquiring of the user whether to newly store the remote device information or update the stored partner user information, as shown in S127 in FIG. 11.

In this state, assume that the user selects “Newly store”. In this case, in step S74, the control unit 10 displays, on the display device 13, a message for inquiring of the user whether to use the device name as the user name, as shown in S128 in FIG. 11. If the user selects “Use” with the input key 14 in response to this inquiry, the control unit 10 respectively writes the Bluetooth® address and the device name in the Bluetooth® address column and the user name column of the corresponding user information in the phone book database 152 in step S75. On the other hand, if the user selects “Not use”, the control unit 10 writes the Bluetooth® address in the Bluetooth® address column of the corresponding user information in the phone book database 152 in step S76. That is, the device name and the Bluetooth® address are written as default information.

Upon completion of the write process of the device name and the Bluetooth® address, the control unit 10 displays, on the display device 13, the user information subjected to the write process, as shown in S129 or 130 in FIG. 11. When the user operates the input key 14 to input characters or numbers while setting a focus to a desired column in this sate, the user can manually store the user name, telephone number, and the like. When the user presses an “OK” button to input the completion of the registration process after the registration process, the control unit 10 detects this operation in step S77. After that, the process shifts to step S81, and the control unit 10 executes the series of connection processes from transmission of the connection request.

On the other hand, assume that the user selects “Update information of stored partner user” in step S73. In this case, the control unit 10 reads the corresponding user information from the phone book database 152 in step S78, and displays it on the display device 13 as shown in S131 in FIG. 11. When the user presses the “OK” button in this state, the process shifts from step S79 to step S80, and the control unit 10 writes the device name and Bluetooth® address of the remote device in the user information. After that, the process shifts to step S81, and the control unit 10 executes the series of connection processes from transmission of the connection request.

(2) Operation of Cellular Phone Which Has Received Connection Request

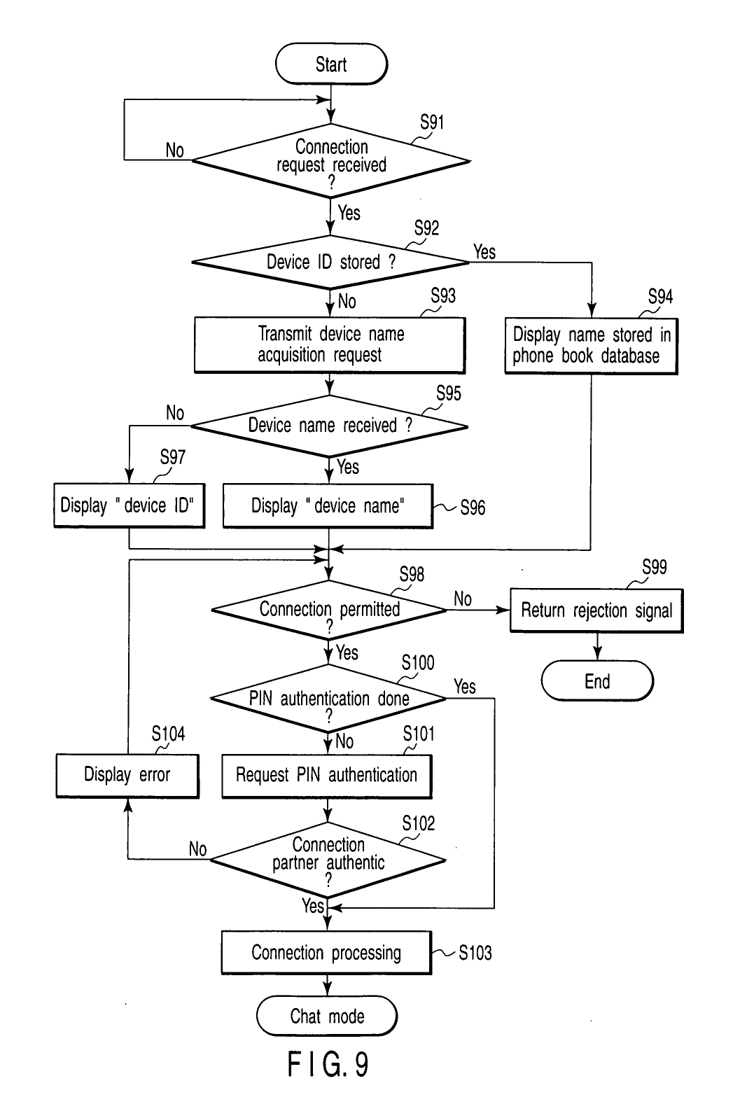

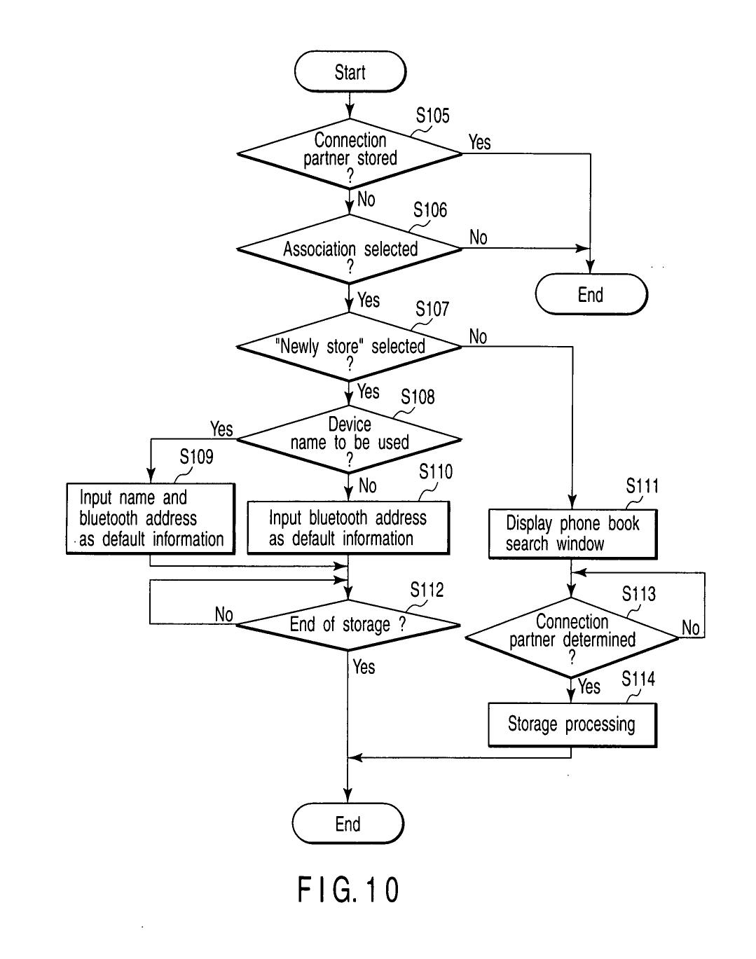

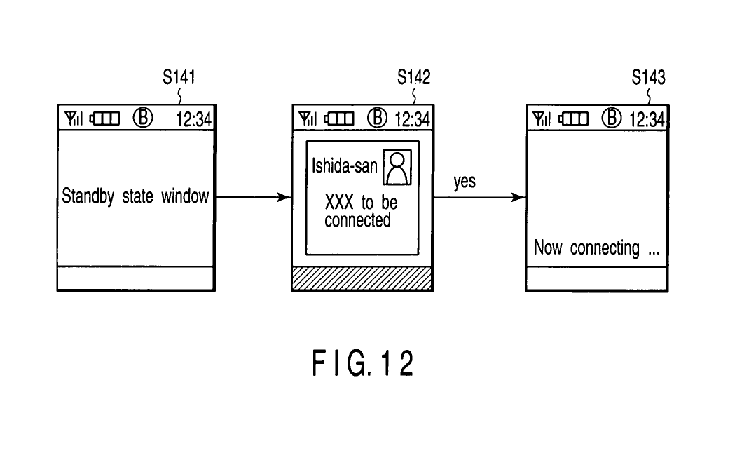

Upon reception of a connection request from another cellular phone in the standby state, the control unit 10 executes control as follows. FIGS. 9 and 10 are flowcharts showing the control sequence and control form, and FIG. 12 is a view showing an example of information displayed on the display device 13 in this control processing.

In the standby state (S141 in FIG. 12), the control unit 10 monitors in step S91 whether a connection request is received. When the Bluetooth® radio unit 12 receives a connection request from another cellular phone in this state, the control unit 10 extracts the device ID (Bluetooth® address) of the transmission source from the received connection request, and determines in step S92 whether the phone book database 152 stores this Bluetooth® address. If the phone book database 152 stores the received device ID based on the determination result, the control unit 10 reads the corresponding user name from the phone book database 152, and displays it on the display device 13. A display example of the user name in this case is shown in S142 in FIG. 12.

On the other hand, assume that the phone book database 152 does not store any received device ID. In this case, the control unit 10 transmits the device name acquisition request to the cellular phone as the connection request source in step S93. When the cellular phone as the connection request source returns the information of the contents of the Bluetooth® table in response to the acquisition request, the control unit 10 determines in step S95 whether the device name is received. If the device name is received based on the determination result, the control unit 10 displays the received device name on the display device 13 in step S96. On the other hand, if the device name cannot be received, the control unit 10 displays, on the display device 13, the device ID (Bluetooth® address) in the information representing the contents of the received Bluetooth® table (step S97).

In step S98, the control unit 10 monitors the connection instruction input operation of the user in a state wherein the user name, device name, or device ID is displayed. In this state, assume that the user performs a rejection operation for the connection request. In this case, the control unit 10 returns a rejection signal in step S99, and returns to the standby state.

On the other hand, assume that the user executes a permission operation for the connection request. In this case, the control unit 10 determines in step S100 whether PIN authentication has been done with the cellular phone as the connection request source. If PIN authentication has been done, the process shifts to step S103, and the control unit 10 executes the connection process. At this time, the display device 13 displays a message “Now connecting . . . ” as shown in S143 in FIG. 12. Upon establishment of the radio link, the control unit 10 shifts to the chat mode hereinafter.

On the other hand, if PIN authentication has not been done, the control unit 10 executes a process for PIN authentication with the cellular phone as a connection request source in step S101. If the authenticity of the cellular phone as the connection request source is confirmed based on this authentication result, the process shifts from step S102 to step S103, and the control unit 10 executes the connection process. After the radio link is established, the control unit 10 shifts to the chat mode hereinafter. If the authenticity of the cellular phone as the connection request source cannot be confirmed based on the PIN authentication result, the control unit 10 displays an error message on the display device 13 in step S104, and returns to the standby state for the connection permission/rejection operation in step S98.

Even when the above-described connection request is received, before or after the connection process in step S103, the control unit 10 controls the phone book database 152 to store the terminal information of the Bluetooth® table, which is transmitted from the cellular phone as the connection request source. FIG. 10 is a flowchart showing the control sequence and control form.

That is, the control unit 10 determines in step S105 whether the phone book database 152 of the mobile terminal stores the cellular phone as the connection request source. If the phone book database 152 stores the cellular phone, the connection process continues. On the other hand, assume that the phone book database 152 does not store the Bluetooth® address of the cellular phone as the connection request source, based on the determination result in step S105. In this case, the control unit 10 generates a message for inquiring of the user whether to store the terminal information of the cellular phone as the connection request source in the phone book database 152, and displays the message on the display device 13. If the user selects “Not store” in this state, the control unit 10 continues the connection process without the registration process for the phone book database.

On the other hand, assume that the user selects “storeRegister”. In this case, in step S107, the control unit 10 displays, on the display device 13, a message for inquiring of the user whether to newly store the terminal information of the cellular phone as the connection request source or update the stored partner user information.

In this state, assume that the user selects “Newly store”. In this case, in step S108, the control unit 10 displays, on the display device 13, a message for inquiring of the user whether to use the device name as the user name. If the user selects “Use” with the input key 14 in response to this inquiry, the control unit 10 respectively writes the Bluetooth® address and the device name in the Bluetooth® address column and the user name column of the corresponding user information in the phone book database 152 in step S109. On the other hand, if the user selects “Not use”, the control unit 10 writes the Bluetooth® address in the Bluetooth® address column of the corresponding user information in the phone book database 152 in step S110. That is, the device name and the Bluetooth® address are written as default information.

Upon completion of the write process of the device name and the Bluetooth® address, the control unit 10 displays, on the display device 13, the user information subjected to the write process. When the user operates the input key 14 to input characters or numbers while setting a focus to a desired column in this sate, the user can manually store the user name, telephone number, and the like. When the user presses an “OK” button to input the completion of the registration process after the registration process, the control unit 10 finds this operation in step S112, and continues the connection process.

On the other hand, assume that the user selects “Update information of stored partner user” in place of “Newly store” in step S107. In this case, the control unit 10 reads the corresponding user information from the phone book database 152 in step S111, and displays it on the display device 13. When the user presses the “OK” button in this state, the process shifts from step S113 to step S114, and the control unit 10 writes the device name and Bluetooth® address of the remote device in the user information.

As described above, in the cellular phone according to this embodiment, when the remote device returns the device ID (Bluetooth® address) in response to the search signal, the display control module 103 of the control unit 10 searches the phone book database 152 based on the device ID, reads the user name of the corresponding remote device, and displays it on the display device 13. When the phone book-database 152 does not store any user name of the corresponding remote device, the display control module 103 acquires the device name from the remote device, and displays it on the display device 13. When the device name cannot be acquired, the display control module 103 displays the device ID on the display device 13.

Accordingly, the user name can be displayed with higher probability in comparison with a case wherein the Bluetooth® table information transmitted from the remote device is unconditionally displayed. Hence, the user can precisely recognize and select a remote device user as the chat partner.

When the user selects the remote device of the chat partner in a state wherein the display device 13 displays the device name, the phone book registration control module 104 of the control unit 10 additionally stores or updates the device name or address of the selected remote device in the phone book database 152 of the mobile terminal. Hence, the user need not manually store the user information of the remote device of the chat partner, thereby largely reducing the operation load on the user.

Note that the present invention is not limited to the above-described embodiment. For example, in the embodiment, the user name, device name, and device ID are displayed in the order of reception as a list when there are plurality of remote devices which have responded to the search signal. However, the priority order may be set in the order of the user name, device name, and device ID, and these pieces of information may be rearranged and displayed in descending order of priority.

An interface based on a local radio communication scheme such as the radio local area network (LAN) or ultra-wideband (UWB) can be used as a local radio communication interface. Additionally, the type and arrangement of the mobile terminal, the control sequence and control form of the control unit, and the content of the data displayed in control processing can be variously modified without departing from the spirit and scope of the invention.

In short, the present invention is not limited to the above embodiments, and can be variously modified and implemented without departing from the spirit and scope of the invention upon practice. Various inventions can be achieved by an appropriate combination of building components disclosed in the embodiment. For example, several building components may be omitted from all the building components described in the embodiment. Further, building components in different embodiments may be properly combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile terminal comprising:
a cellular radio communication unit configured to perform cellular radio communication with a base station;
a local radio communication unit configured to perform local radio communication with a remote terminal;
a storage unit configured to store information;
a display unit configured to display information; and
a control unit connected to the cellular radio communication unit, the local radio communication unit, the storage unit, and the display unit,
the storage unit further comprising
a phone book memory configured to store phone book data containing at least a user name of the remote terminal, which represents the remote terminal estimated as a communication destination in the cellular radio communication or the local radio communication, and
the control unit further comprising
a first control module configured to receive, via the local radio communication unit, local radio communication terminal identification information which is transmitted from the remote terminal and contains at least an address of the remote terminal,
a second control module configured to determine whether the phone book memory stores the address contained in the received terminal identification information, and
a third control module configured to read the user name of the remote terminal corresponding to the address from the phone book memory and display the read user name on the display unit, when it is determined that the phone book memory stores the address contained in the received terminal identification information.

2. The terminal according to claim 1, wherein the control unit further comprises
a fourth control module configured to execute a process of receiving a device name of the remote terminal from the remote terminal which has transmitted the terminal identification information, when it is determined that the phone book memory does not store the address contained in the received terminal identification information, and
a fifth control module configured to determine whether the device name of the remote terminal is received, and display the received device name on the display unit when it is determined that the device name is received.

3. The terminal according to claim 2, wherein the control unit further comprises a sixth control module configured to display, on the display unit, the address contained in the received terminal identification information when it is determined that the device name of the remote terminal is not received.

4. The terminal according to claim 1, wherein the first control module configured to receive the terminal identification information transmits a search signal from the local radio communication unit to the remote terminal in response to an operation of requesting a chat with the remote terminal, and receives, via the local radio communication unit, the terminal identification information returned as a response signal from the remote terminal which has received the search signal.

5. The terminal according to claim 1, wherein the control unit further comprises, when a user operates to select a chat partner from remote terminals in a state in which user names, device names or addresses of the remote terminals are displayed on the display unit, a seventh control module configured to execute connection control for establishing a radio link for a chat with the selected remote terminal.

6. The terminal according to claim 2, wherein the control unit further comprises a storage control module configured to store, when a user operates to select a remote terminal as a local communication partner in a state in which a device name of the remote terminal is displayed on the display unit, the terminal identification information received from the remote terminal selected by the operation, in the phone book memory as phone book data.

7. The terminal according to claim 6, wherein the storage control module displays, on the display unit, a message for inquiring permission/rejection of storing the received terminal identification information, and stores, in the phone book memory, the terminal identification information of the selected remote terminal when the user operates to permit storing the terminal identification information.

8. The terminal according to claim 7, wherein the storage control module displays, on the display unit, a message for inquiring of the user whether to store the device name in the received terminal identification information in place of the user name, when the user operates to permit storing the terminal identification information, and stores, in the phone book memory, the device name in the received terminal identification information in place of the user name when the user operates to instruct to store the device name in place of the user name.

9. The terminal according to claim 8, wherein the storage control module stores, in the phone book memory, the address contained in the received terminal identification information, when the user operates to instruct not to store the address in place of the user name.

10. The terminal according to claim 6, wherein the storage control module reads the phone book data to be updated and displays the phone book data on the display unit when the user operates to request to update the phone book data stored in the phone book memory, and updates the phone book data in response to an updating operation for the displayed phone book data.
